(19) United States
(12) Patent Application Publication
(10) Pub. No.: US 2005/0169627 A1
(43) Pub. Date: Aug. 4, 2005

(54) Built-in cartridge shutter lens barrel and camera device using the same

(75) Inventor: Takahiro Kawauchi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/042,738

(22) Filed: Jan. 25, 2005

(30) Foreign Application Priority Data
Feb. 2, 2004 (JP) 2004-024954

(51) Int. Cl. G03B 9/08

(52) U.S. Cl. 396/451

(57) ABSTRACT

There is provided a lens barrel having a shutter unit capable of being slimmed by disposing an actuator for driving a shutter blade in a convex portion of the shutter unit and by disposing one of a plurality of lenses in an outer peripheral side of the convex portion. In a state of supporting a shutter blade, a base member as a supporting member is built in a lens barrel, a convex portion having a hollow inner shape is formed at an outer peripheral side of the base member, and an actuator (not shown), which enables an opening to open and shut by driving the shutter blade, is disposed in the hollow convex portion. In the base member, a concave portion is formed at an inner peripheral side of the convex portion, and one of the plurality of lenses is disposed in the concave portion, by which slimming can be achieved.

### BACKGROUND OF THE INVENTION

1. Field of the Invention

The present invention relates to a built-in shutter lens barrel used in a digital still camera and the like.

2. Description of the Related Art

Generally, as in a conventional shutter unit disclosed in Japanese Unexamined Patent Application Publication No. 2000-310803, in which a zoom lens barrel has a built-in shutter unit, as shown in FIG. 3, a flat glass 2 is fixed to a front end of the front barrel 1.

Inside the front barrel 1, a first group of lenses 3 for adjusting focus is mounted on a movable frame 4.

The movable frame 4, on which the first group of lenses 3 is mounted, is supported by guide bars 10 and 11 and is movable parallel to an optical axis.

Further, a shutter unit 5 is fixed to a movable frame 7 so as to be positioned immediately in front of a second group of lenses 6 having zoom lenses. The movable frame 7, on which the second group of lenses 6 is mounted, along with the shutter unit 5, is supported by the guide bars 10 and 11 and is movable parallel to the optical axis like the first group of lenses 3.

A rear barrel 9, to which a third group of lenses 8 is mounted, is disposed behind the second group of lenses 6.

In the shutter unit 5, an actuator capable of shielding the light transmitted through the second group of lenses 6 and controlling the quantity of light by driving a plurality of blades (not shown), is formed to protrude toward the second group of lenses 6, i.e., toward the rear side of the shutter unit 5.

The aforementioned conventional shutter unit 5 is disposed immediately in front of the second group of lenses 6, and the actuator (not shown) for driving the plurality of blades is formed to protrude toward the second group of lenses. Thus, the conventional shutter unit has problems in that, although the second group of lenses 6 is intended to be made slim to accomplish the compactness of a camera device, the compactness cannot be achieved because of the impeding actuator protruding backward from the shutter unit 5.

### SUMMARY OF THE INVENTION

The present invention has been made to solve the above problems, and it is an object of the present invention to provide a lens barrel in which a shutter unit capable of being slimmed is built by disposing an actuator for driving a shutter blade in a convex portion of the shutter unit and by disposing one of a plurality of lenses at an inner peripheral side of the convex portion.

As a first means to solve the problem, a built-in shutter lens barrel comprises a lens barrel in which a plurality of lenses are received, a shutter blade for shielding light incident into the lens barrel, and a supporting member for supporting the shutter blade so as to shield the light. The supporting member is built in the lens barrel in a state supporting the shutter blade, and a convex portion having a hollow inner portion is formed at an outer peripheral side. An actuator capable of shielding the incident light by driving the shutter blade is disposed in the hollow convex portion. A concave portion is formed at an inner peripheral side of the convex portion of the supporting member, and one of the plurality of lenses is disposed in the concave portion.

As a second means to solve the problem, the plurality of lenses has a first group of lenses composed of eye lenses, a front wall having an opening with a predetermined aperture is formed in the lens barrel, a lens holding portion protrudes inward from the front wall to hold the first group of lenses, and the concave portion of the holding member is inserted into the lens holding member.

As a third means to solve the problem, a stopper member is disposed behind a rearmost lens of the plurality of lenses.

As a forth means to solve the problem, a camera device using the built-in shutter lens barrel comprises an image pickup element disposed behind the plurality of lenses and on an optical axis of the lenses.

A built-in shutter lens barrel of the present invention comprises a lens barrel in which a plurality of lenses is received, a shutter blade for shielding light incident into the lens barrel, and a supporting member for supporting a shutter blade so as to shield the light. The supporting member is built in the lens barrel in a state supporting the shutter blade, and a convex portion having a hollow inner portion is formed at an outer peripheral side. An actuator capable of shielding the incident light by driving the shutter blade is disposed in the hollow convex portion. A concave portion is formed at an inner peripheral side of the convex portion of the supporting member, and one of the plurality of lenses is disposed in the concave portion. Thus, the thickness of one of the plurality of the lenses can be offset in the concave portion of the shutter unit, which makes the lens barrel having the shutter unit built therein slim.

The plurality of lenses has a first group of lenses composed of eye lenses, a front wall having an opening with a predetermined aperture is formed in the lens barrel, a lens holding portion protrudes inward from the front wall to support the first group of lenses, and the concave portion of the holding member is inserted into the lens holding member. Thus, the shutter unit can be mounted in the lens barrel by only inserting the concave portion into the lens holding portion, which leads to improved assembling.

A stopper member is disposed behind the rearmost lens of the plurality of lenses. Thus, the plurality of lenses can be prevented from falling out by only press-fitting the stopper member into the lens barrel, which leads to more improved assembling.

Handling the lens barrel after assembling is easy because the stopper member prevents lenses from falling out.

A camera device of the present invention comprises an image pickup element disposed behind the plurality of lenses and on an optical axis of the lenses. Thus, a slimmed camera device by disposing the image pickup element in a lens barrel capable of being slimmed can be provided.

### BRIEF DESCRIPTION OF THE DRAWINGS

FIG. 1 is an exploded perspective view of a lens barrel having a built-in shutter unit and a camera device using the barrel according to a preferred embodiment of the present invention;

FIG. 2 is an essential cross-sectional view of the lens barrel having the built-in shutter unit and the camera device using the barrel according to the preferred embodiment of the present invention;

FIG. 3 is an essential cross-sectional view of a lens barrel having a conventional built-in shutter unit.

### DESCRIPTION OF THE PREFERRED EMBODIMENT

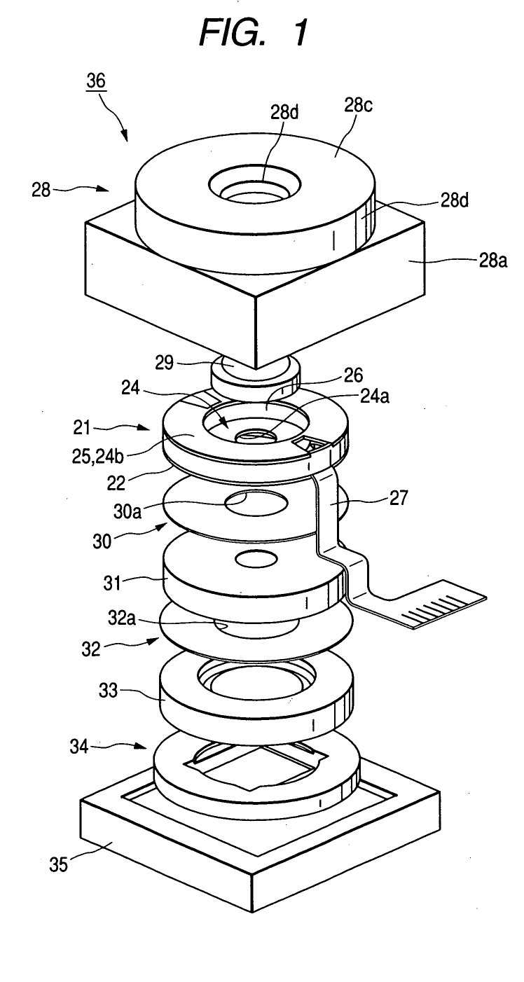

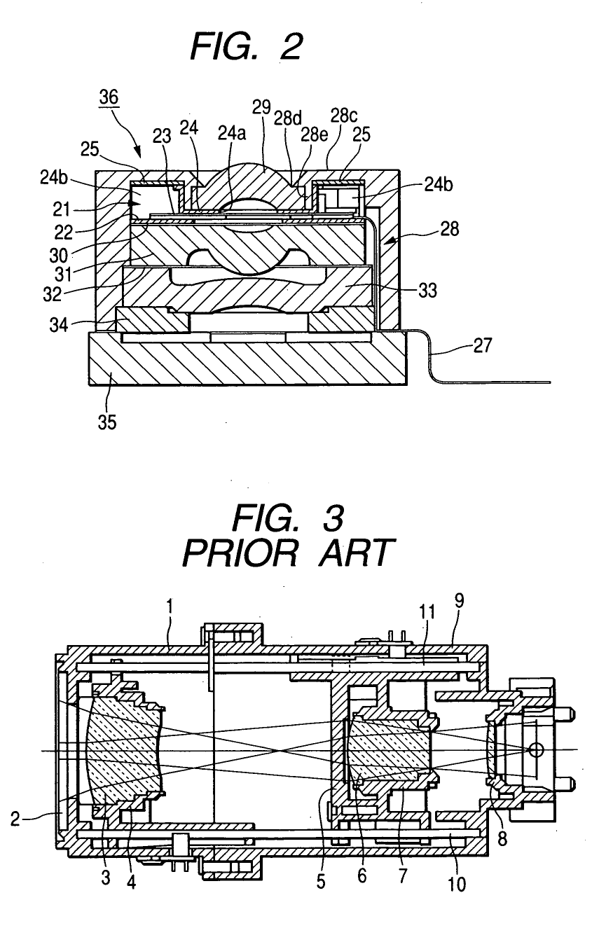

Hereinafter, a preferred embodiment of a lens barrel having a built-in shutter unit and a camera device using the barrel according to the present invention will be described with reference to the drawings. FIG. 1 is an exploded perspective view illustrating a lens barrel having a built-in shutter unit and a camera device using the barrel; FIG. 2 is an essential cross-sectional view of the lens barrel having a built-in shutter unit and the camera device using the barrel.

First, the preferred embodiment of the present invention will now be described with reference to FIG. 1 and FIG. 2. A shutter unit 21 has a bottom cover 22 having a round outer shape. A shutter blade 23, which enables an opening 24a of a base member 24 to open and shut, described below, is placed on the bottom cover 22.

The base member 24 as a supporting member of the shutter blade 23 is placed on the shutter blade 23, and the opening 24a having a predetermined aperture is formed at a center of the base member 24.

The shutter blade 23 is disposed under a surface of base member 24 and is supported by the base member 24 as a supporting member in order to enable the opening 24a to open and shut.

Namely, the shutter blade 23 is supported by the base member 24 in order to shield light incident through the opening 24a into a lens barrel 28, which will be described below.

A convex portion 24b having a hollow inner shape is formed at an outer peripheral side of the base member 24. An actuator (not shown), which enables the opening 24a to open and shut by driving the shutter blade 23, is disposed in a hollow portion of the convex portion 24b.

Although not shown, the actuator is constructed such that a coil wound in a form of a sheet and a sheet-like magnet that is disposed on an opposite side of the coil are placed. Magnetic flux, generated by allowing current to flow through the coil, affects the current in a magnet. Therefore, a link member to which the magnet is mounted rotates like a seesaw.

By the rotation of the link member, a blade supporting member which is formed at an end of the link member actuates the shutter blade 23 to drive the shutter blade in a direction that the opening 24a opens and shuts. A top cover 25 having a donut shape is disposed above the convex portion 24b and covers the convex portion 24b.

At an inner peripheral side of the convex portion 24b, a concave portion 26 having a predetermined size is formed. The opening 24a is exposed to the concave portion 26.

An FPC (flexible PCB) 27, connected to an interior actuator and designed to allow the current to flow through the coil which constitutes the actuator, is drawn out of the convex portion 24b.

The lens barrel 28 having the built-in shutter unit 21 with such a constitution is made of a resin material. A rectangular parallelepiped 28a is formed at a lower portion of the lens barrel 28, a cylindrical portion 28b is formed at an upper portion of the lens barrel 28, and an inside of the lens barrel 28 is hollow.

An opening 28d having a larger aperture than the opening 24a of the shutter unit 21 is formed at a center of a front wall 28c of the cylindrical portion 28b. A first group of lenses 29, an eye lens, is held in the opening 28d.

In the lens barrel 28, a lens holding portion 28e protrudes inward from the front wall 28c where the opening 28d is formed, and the first group of lenses 29 is held in the lens holding portion 28e by press-fitting and the like.

A concave portion 26 is inserted into the lens holding portion 28e holding the first group of lenses 29a, so that the shutter unit 21 is assembled and built inside the lens barrel 28.

A first spacer 30 in a form of a film is disposed and built below the shutter unit 21 mounted on the lens holding portion 28e.

An opening 30a having a larger aperture than the opening 24a of the shutter unit 21, is formed at a center of the first spacer 30.

A second group of lenses 31 is disposed and built under the first spacer 30, and a second spacer 32 is disposed under a second group of lenses 31. An opening 32a having a larger aperture than the opening 24a of the shutter unit 21, is formed at a center of the second spacer 32.

A third group of lenses 33 of a plurality of lenses, located at a rearmost position, is disposed under the second spacer 32, and a stopper member 34 is disposed behind the third group of lenses 33. The stopper member 34 is mounted in the lens barrel 28 by press-fitting or the like.

The stopper member 34 prevents lenses 29, 31 and 33 and the shutter unit 21 built in the inner hollow portion of the lens barrel 28 from falling out, thereby forming the lens barrel 28 having a built-in shutter unit.

Such a lens barrel 28 can be made slim by disposing the first group of lenses 29 in the concave portion 26 of the shutter unit 21.

Handling the lens barrel 28 after assembling is easy because the stopper member 34 prevents lenses 29, 31, 33 and the shutter unit 21 from falling out.

An image pickup element 35, comprising CCD or CMOS, is disposed behind the stopper 34 and on an optical axis (not shown) on which lenses 29, 31 and 33 are placed. A camera device 36 is constructed by using the lens barrel 28 in which the shutter unit of the invention is built.

The camera device 36 is easily assembled and can be made slim by mounting the image pickup element 35 in the lens barrel 28 where the plurality of interior lenses 29, 31 and 33 are prevented from falling out by the stopper member 24.

In the description of the preferred embodiment of the present invention, the first group of lenses 29 is disposed in the concave portion 26 of the shutter unit 21, but the shutter unit 21 may be disposed behind the second group of lenses 31, and the second group of lenses 31 may be disposed in the concave portion 26.

The shutter unit 21 may be disposed behind the third group of lenses 33, and the third group of lenses 33 may be disposed in the concave portion 26.

Namely, any one of the groups of lenses may be disposed in the concave portion 26 of the shutter unit 21.

1. A built-in shutter lens barrel comprising:
a lens barrel in which a plurality of lenses are received;
a shutter blade for shielding light incident into the lens barrel; and
a supporting member for supporting a shutter blade so as to shield the light,
wherein the supporting member is built in the lens barrel in a state supporting the shutter blade, and a convex portion having a hollow inner portion is formed at an outer peripheral side,
an actuator capable of shielding the incident light by driving the shutter blade is disposed in the hollow convex portion,
a concave portion is formed at an inner peripheral side of the convex portion of the supporting member, and one of the plurality of lenses is disposed in the concave portion.

2. A built-in shutter lens barrel according to claim 1,
wherein the plurality of lenses has a first group of lenses composed of eye lenses, a front wall having an opening with a predetermined aperture is formed in the lens barrel, a lens holding portion protrudes inward from the front wall to hold the first group of lenses, and the concave portion of the holding member is inserted into the lens holding member.

3. A built-in shutter lens barrel according to claim 1,
wherein a stopper member is disposed behind a rearmost lens of the plurality of lenses.

4. A camera device comprising an image pickup element disposed behind the plurality of lenses according to claim 1 and on an optical axis of the lenses.
